(19) United States
(12) Patent Application Publication
(10) Pub. No.: US 2012/0059712 A1
(43) Pub. Date: Mar. 8, 2012

(54) WEB ENHANCING SYSTEMS AND METHODS

(76) Inventor: James R. Stalker, Las Cruces, NM (US)

(21) Appl. No.: 12/964,201

(22) Filed: Dec. 9, 2010

Related U.S. Application Data
(60) Provisional application No. 61/285,648, filed on Dec. 11, 2009.

(51) Int. Cl. G06F 15/16; G06Q 30/00

(52) U.S. Cl. 705/14.47; 709/203

(57) ABSTRACT

A web based system with (a) a data server, (b) a web server, and (c) a client server with web browser capability is disclosed that utilizes, manipulates, and creates web content. The system uses additional web servers and other devices such as cameras, camcorders, microphones, trucks, storage units, etc. to result in innovative system capabilities. Eight specific innovative systems resulting from this invention are disclosed in this patent application: (i) web content authentication system, (ii) linguistic vocal sounds registration system, (iii) web ad authentication system, (iv) web-based functionality/interactivity system, (v) web-based expert consulting system, (vi) web-based logo branding system, (vii) web-based grocery shopping system, and (viii) a Point-N-Learn system.

### STATEMENT REGARDING FEDERALLY SPONSORED R&D

Not Applicable.

### NAMES OF PARTIES INVOLVED IN THIS INVENTION

James R. Stalker is the sole inventor of this invention.

### CROSS REFERENCES TO RELATED APPLICATIONS

This application is related to and claims priority to a provisional patent application submitted by James R. Stalker, dated Dec. 11, 2009 (App No. 61/285,648).

### BACKGROUND OF THE INVENTION

1. Field of the Invention

This invention is related to the field of the world wide web, hereafter the web or the internet, that allows development of innovative systems and methods to enhance web experience and web content utilization.

2. Description of the Prior Art

The world-wide-web (the “web” or the internet) plays such a significant role in people's lives today all over the globe. This role is only going to increase in the future. It is conceivable that more and more people are going to use the web for all types of information. The web is used to gather information about products and services to make buying decisions, order those products and services on the web (online), to find directions to places, to find people's contact information, get and stay connected with people via email, social network web sites, etc., to research a wide variety of topics, to find customers via advertisements, etc., to just mention a few of the numerous applications for web based information. This versatile and universal medium offers a great deal of opportunity for a great number of inventions and for enhancing web experience and for generating wealth through web-based high-tech businesses. A series of innovative systems and methods for the web, with the web at the focal point, are disclosed as part of the invention.

Specifically, the following eight web enhancing systems and methods are included in this application: (1) web content authentication systems and methods, (2) web-based linguistic vocal sounds systems and methods, (3) web advertisement authentication systems and methods, (4) web-based functionality/interactivity systems and methods, (5) web-based expert consulting systems and methods, (6) web-based logo branding systems and methods, (7) web-based grocery shopping systems with innovative delivery systems/methods, and (8) web-based Point-N-Learn systems and methods.

The current invention is about innovative utilization, manipulation, and creation of web content. Prior art is summarized here with respect to the eight distinct but closely related items identified in paragraph [0006].

Web has seen explosive growth and adoption since its beginnings in the early 1990′s. In this context, there is a vast number of patents issued related to the web. With this context in mind, several patents are referred to in this application, if and when such patents are somewhat related and/or remotely related to the areas of invention disclosed here. U.S. Pat. No. 7,519,680) is found to address the general issue of internet capability. With respect to the web content authentication systems and methods (paragraph 0006, item 1), U.S. Pat. Nos. 7,752,553, 7,694,328, 7,603,131, 7,587,488, 7,454,615, 7,140,045, 7,765,481, 7,739,280, 7,483,910, 7,478,330, 7,295,677, and 7,240,192) are referred to in this application. With respect to the linguistic vocal sounds systems and methods (paragraph 0006, item 2), U.S. Pat. Nos. 7,712,020, 7,216,287, 6,732,117, 6,721,781, 7,769,589, 7,107,215, 7,076,423, 6,227,863, 6,126,447, 5,918,206, 5,727,120, and 5,713,739) are referred to in this application. With respect to the web advertisement authentication systems and methods (paragraph 0006, item 3), U.S. Pat. Nos. 7,747,619, 7,734,632, 7,593,965, 7,657,638, 7,653,748, 6,816,857, and 6,128,655) are referred to in this application. With respect to the web functionality and interactivity systems and methods (paragraph 0006, item 4), U.S. Pat. Nos. 7,721,228, 7,506,260, 6,167,441, 7,519,573, 7,386,783, 7,174,506, 7,131,062, 7,043,685, 7,010,581, 6,976,090, 6,732,781, 6,453,342, 6,330,592, and 7,237,002) are referred to in this application. With respect to the web-based expert consulting systems and methods (paragraph 0006, item 5), U.S. Pat. Nos. 7,739,140, 7,379,704, and 7,050,753) are referred to in this application. With respect to the web-based logo branding systems and methods (paragraph 0006, item 6), U.S. Pat. Nos. 6,850,988 and 6,650,348) are referred to in this application. With respect to the web-based grocery shopping systems and methods (paragraph 0006, item 7), U.S. Pat. Nos. 7,685,341, 7,600,025, and 7,242,925) are referred to in this application. Finally, with respect to the Point-N-Learn systems and methods (paragraph 0006, item 8), U.S. Pat. No. 7,792,682) is referred to in this application.

### SUMMARY OF THE INVENTION

Web content authentication systems and methods: Currently there is no good way to tell whether or not the content of a web page a web visitor reaches on the web is authentic or not. Anyone can develop a web page and publish any content they wish on any subject. For the inexperienced web visitor, though, the thousands of web sites offering disparate information about the same subject matter or about related subject matters become rather useless and/or confusing and can potentially waste the web visitor's time at the very least on the one hand and completely mislead the web visitor with incorrect information, on the other hand. An invention to authenticate web content can minimize this issue and possibly eliminate the issue completely over a period of time.

An inventive web content authentication system is developed as part of this patent application. For this system, web page owners/webmasters register their web content with a centralized web content authentication company (Universal Web Content Authentication Services—UWCAS Corp—www.uwcascorp.com) and receive different levels of authentication for their web content. The crux of the invention is about how web content is authenticated and how various levels of authentication are requested and displayed on the web. Web page owners pay for the authentication services that UWCAS Corp offers but basic authentication will be offered free of charge to anyone who wants to receive such authentication.

Web-based linguistic vocal sounds systems and methods: People (young and old, males and females of all ages) all over the world possess unique vocal voices. Because their voices are unique, it is only a matter of time before listeners grow to like those voices. As a matter of fact, there are no voices in the world that are not technically likeable. There are only two types of voices, i.e., those that have been heard by many and liked by quite a few of those who have heard the voices and those voices that have not been heard yet. The invention presented here, and the business model developed based on the invention, essentially promote and support that fundamental premise that all voices are unique and must be heard. In other words, one does not have to be a superstar singer to be liked by listeners. In this context, as many distinct voices as possible must be captured, played, used in many different ways for listeners and other voice users across the globe.

The part of the invention developed here is about capturing the unique linguistic vocal sounds (e.g., English) of the participants in the program. A new global company called ‘Unique Voices of the World Corp—UVOW Corp—www.uvowcorp.com) will be established. UVOW Corp will register, into an online database, the twenty vowel sounds and the twenty-four consonant sounds of the English language produced by its participants. These sounds are then used for composing new songs, for “duping” existing songs, in reading books, for identification by voice, etc., etc. just to mention a few of the applications.

As for the business model, sound registrants own their sound assets and can get compensated for if someone uses their sounds in composing songs, reading books, etc. or when they sell their own songs online. UVOW Corp will get a management fee for managing such transactions. However, UVOW Corp can manage a registrant's sound assets on the registrant's behalf, if such an agreement is made between the registrant and UVOW Corp. In the latter case, UVOW Corp will keep the lion share of the profit and the registrant gets a royalty fee every time the registrant's sounds get used.

This invention potentially enables every registrant in the world to make money from his/her unique linguistic vocal sounds online. Appropriately, some of the suggested slogans for UVOW Corp are: ‘UVOW to make yourself heard’ and ‘UVOW to make yourself money.’

Web advertisement authentication systems and methods: Internet based advertisement (ad for short) will pretty much replace many of the advertisement channels in existence today in the very near future (in 5 to 10 years). Online viewing of advertisements needs to be authenticated. The first version of the ad authentication system is about how online visitors get authenticated by a live person. In other words, when a web visitor to a web page clicks on an ad (or a logo, etc.), then that person is connected with a live person either on the phone or on the web using such programs as online chat or other video based interactive medium. Upon a web visitor gets authenticated by the live person, either by having the ad content read or is made to click on additional buttons provided by the live person, the advertisement is considered properly viewed and authenticated. These live authentication personnel will work for an ad authentication company (Universal Web Ad Authentication Services—UWAAS Corp—www.uwaascorp.com).

This ad authentication company can eventually develop a second-generation version of the ‘ad authentication’ system, by combining the voice databases developed for UVOW Corp and the new ad authentication interface. In other words, web visitors to any web pages click on ads (or ad logos) and read the content into a microphone, then their voice is detected in the databases (to be licensed from UVOW Corp) and the visitors' ad clicks are automatically authenticated. This latter version will eliminate the need for hundreds and thousands of live personnel, working for Universal Web Ad Authentication Services.

Web-based functionality/interactivity systems and methods: The standard web browsers that are available today can be enhanced for additional functionality and interactivity. Several additional buttons are developed as part of this invention. Some examples are discussed as part of this summary description. For example, a button named, ‘PageHistory,’ will be developed. This button will allow a web visitor to choose specific pages that the web visitor has browsed during a web browsing session. When you click on this button, sequentially numbered hyperlinks to these pages are displaced. By clicking on the specific number, the web visitor is taken to the web page corresponding to that number. The visitor can reset the numbering function just by clicking the ‘PageHistory’ button.

Another example is about a button (‘Admin’) that an owner/webmaster can log in to make web browsing more useful and customized for a specific web visitor or give him/her access to a secure version of the web pages or a specific web page. The ability to manage this functionality on the client side for the web page owner than on the server side can be effective in creating a more dynamic, tailor-made, and highly interactive web browsing experience for the web visitor. Simultaneously, web browsers will be offered a button (‘Visitor’) for the purposes of receiving real-time instructions (e.g., passwords, etc.) from the owner/webmaster. In addition to the ability to receive such critical information as passwords, the web visitor can receive other valuable information about web site stats, reviews, and testimonials about the web page(s) without password authentication requirements.

Another button (‘DoMore’) is also disclosed that allows the web visitor to not only read web content but also manipulate it. For example, this button will allow the visitor to get synopses of the content, make numerical analyses based on the content, save their analyses and reports to their own computer hard drives.

Web-based expert consulting systems and methods: In the explosively growing world of the internet, more and more digital information is added to the web each day and is made accessible to anyone with a computer and access to the internet. However, the complexity and relevance of the information may be beyond many individuals browsing the internet. This presents an opportunity when the person browsing the internet has questions or requires further information to solidify their thought process about the content dealing with a specific subject. It will be good for the person to pick up the phone or initiate an online chat with an expert, as and when required on demand. These experts are referred to as web expert consultants here that work for a company called Universal Web Expert Consulting (UWEC Corp—www.uweccorp.com). UWEC Corp will hire these experts from around the world as part-time/full-time consultants and develop a web interface (system) to connect the web visitors with the web expert consultants in real time. Depending on how seamlessly UWEC Corp can offer these consulting services, the market potential for this business is extremely high since the scope of this business model is undoubtedly global.

Web-based logo branding systems and methods: All businesses intrinsically project an image in the market place. Whether this image is positive or negative or neutral depends on how these businesses function with respect to developing the right products and offering meaningful services that their customers can use. This image is often remembered in association with a company's logo. Also, logos can be successfully used to draw the attention of a potential customer to a company's great products and services. So logos are not just space fillers on web pages with graphics, letters, etc. A logo plays a critical role in a company's success and longevity. If people see a logo a number of times, it will most likely stick in their heads. They either know about the company the logo represents or start collecting bits and pieces of information about the company subconsciously as they come across the logo again the next time or they may even want to specifically learn more about the company. In other words, there is a need for logos to be displayed and managed at a single web site location. There is huge potential to cater to this business need and the invention here addresses this need.

This invention is about addressing the question, “Can we build a web site that meets the above-mentioned enterprise need for building an effective company image that is all about logos?” A company called “Global Logo Mania” (www.Global-Logo-Mania.com) will be created for this purpose. This invention is all about making Global Logo Mania (GLM) a universal logo company on the web. In other words, GLM will be a company for logos similar to what social network sites offer for people about people.

Web-based grocery shopping systems with innovative delivery systems/methods: The way grocery shopping is done these days is pretty ancient compared to today's standards. Besides, grocery shopping has not seen much innovation at least over the last couple of decades. People still spend quite a few hours of time on a regular basis (once or twice a week) to buy groceries from the grocery stores. In addition to the demand on the shoppers' time, this current shopping mode involves huge transportation costs for all individual shoppers as well. If a novel delivery system combined with the ability for shoppers to view and choose items of interest remotely, i.e., from the comfort of their own homes, such an invention will save a lot of time and energy that could be spent elsewhere. The current invention is about developing a web-based grocery ordering system and a novel delivery system. The invention related to the delivery system presented here plays a key role as it significantly augments the method of the semi-automated grocery shopping endeavor.

As part of this invention, participating grocery stores are fully connected to the web. This means that all items in these grocery stores can be viewed online in real time via web cams, etc. Shoppers will visit corresponding web sites of the grocery stores and choose the items they like and add them to their list of items to be ordered. Because most of the required technologies exist today, a web interface to order groceries online and a grocery delivery system, that will fully complement the web-based grocery shopping model, can be developed for making grocery shopping an energy efficient and time-saving endeavor.

Web-based Point-N-Learn systems and methods: Millions of people visit millions of places to see and learn in every corner of the world every day. And, yet, we often hear people ask the same question time and time again, “What is that?” An invention is developed here to answer this very question using the power of the internet. A system that can be worn around the neck or held in hand and pointed to as a flashlight or looked through as a system similar to a pair of binoculars, with the capability to display information visually and/or provide audio information feeds to the user through a set of headphones. This system will enable visitors to learn about what they happen to see while visiting brand new places or places they keep going back to, at their own pace and at their comfort level. Families or groups of students or other groups of tourists can learn about their natural and man-made environments together.

The way the Point-N-Learn system works is through accessing huge web databases online. The sites (or areas) of interest must be mapped out to the desired level of detail and the information, in the form of audio, video, text, etc., associated with each of those sites and the components within them (e.g., historic buildings, canyons, rivers, etc.) must be stored into these databases. These databases will be accessed on demand in real time as people explore sites (or areas) in totality or any specific sub regions within those areas.

For example, if a National Park signs up as a participant in this program, they will approach the company called Universal Web Information Services (UWIS Corp—www.uwiscorp.com), to get their Park area fully mapped out and included in the web databases. UWIS Corp will acquire the required information and update the information as needed and develop and maintain the web databases for its clients.

Once the web databases are fully developed and made available for access by UWIS Corp, the Point-N-Learn system will allow its users to obtain specific information about objects of interest by simply pointing the device to those sites, areas, etc.

### BRIEF DESCRIPTION OF THE DRAWINGS

FIG. 1a is a web page schematic of a first-generation web content authentication system.

FIG. 1b is a web page schematic of a second-generation web content authentication system.

FIG. 1c is a web page schematic of a second-generation web content authentication system, illustrating web domain authentication.

FIG. 1d is a web page schematic of a second-generation web content authentication system, illustrating web content authentication.

FIG. 1e is a schematic of pertinent internal steps to build a second-generation web content authentication system.

FIG. 2a is web page schematic of a web portal to register linguistic vocal sounds with UVOW Corp.

FIG. 2b shows linguistic vocal sound registration code (nomenclature).

FIG. 2c shows tabular formatted linguistic vocal sound symbols for twenty vowels and twenty-four consonant sounds. These symbols are adopted from the International Phonetic Alphabet (IPA).

FIG. 2d is a web page schematic of a linguistic vocal sound registrant's account management portal.

FIG. 2e is a web page schematic of a UVOW Corp system administrator portal.

FIG. 3a is a web page schematic of a UWAAS Corp first-generation web advertisement authentication system.

FIG. 3b is a web page schematic of a UWAAS Corp second-generation web advertisement authentication system.

FIG. 4a is a web page schematic of ‘PageHistory’ button for enhanced web functionality and interactivity.

FIG. 4b is a web page schematic of ‘Admin’ an ‘Visitor’ buttons for targeted web page sharing/viewing, with a concept of making web pages available within web pages, for enhanced web functionality and interactivity.

FIG. 4c is a web page schematic of ‘DoMore’ button for enhanced web functionality and interactivity.

FIG. 5a is a web page schematic of first-generation ‘GetAnExpert’ system to facilitate expert consulting on the web.

FIG. 5b is a web page schematic of second-generation ‘GetAnExpert’ system to facilitate expert consulting on the web.

FIG. 6 is a web page schematic of Global Logo Mania (GLM) web interface system.

FIG. 7a is a web page schematic of a web-based grocery ordering system with a first-generation delivery method.

FIG. 7b is a second-generation grocery delivery system for a web-based grocery ordering system.

FIG. 8 is an illustration of a Point-N-Learn system with a web page schematic of a web interface system.

### DETAILED DESCRIPTION OF THE INVENTION

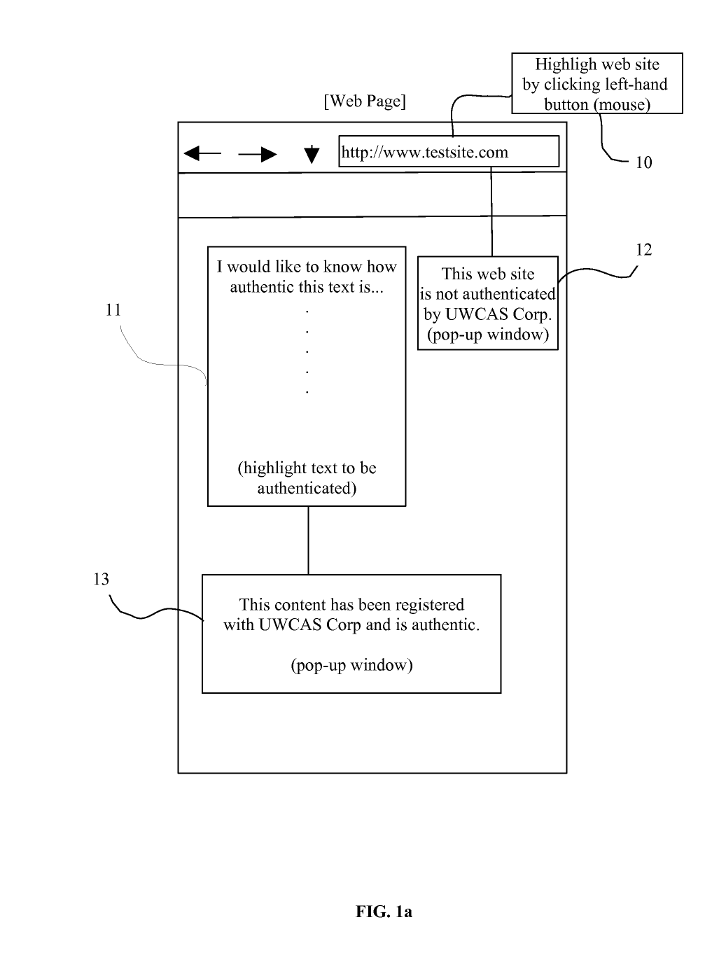

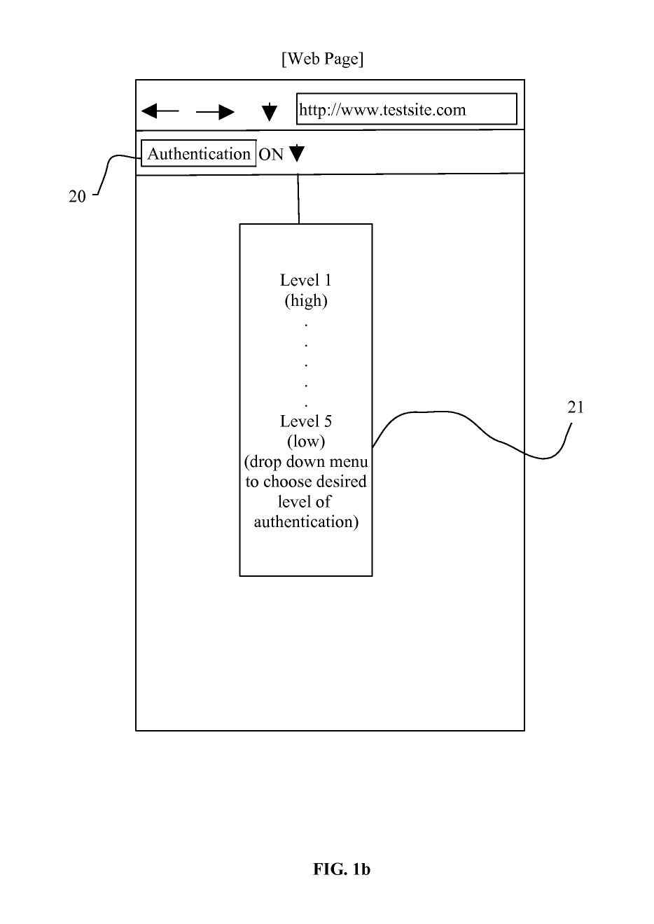

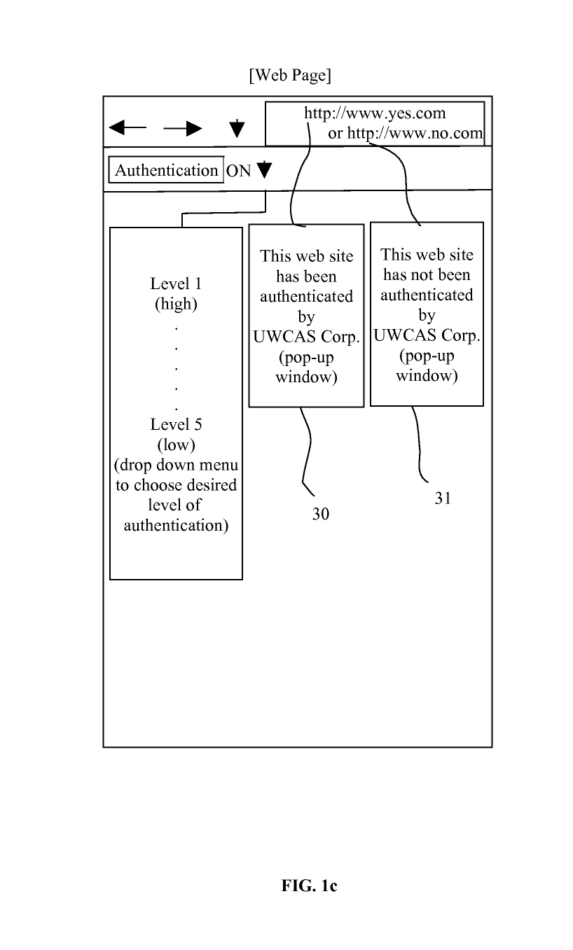

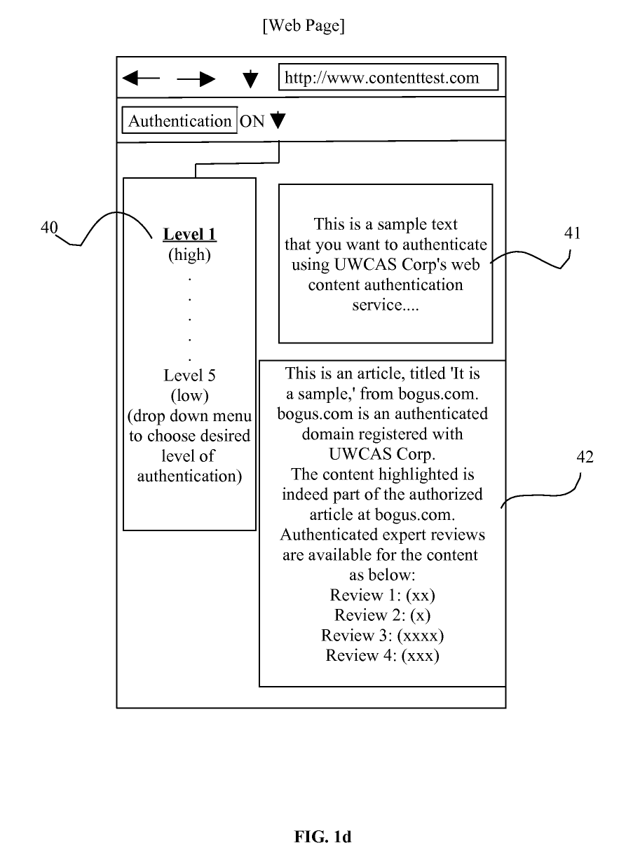

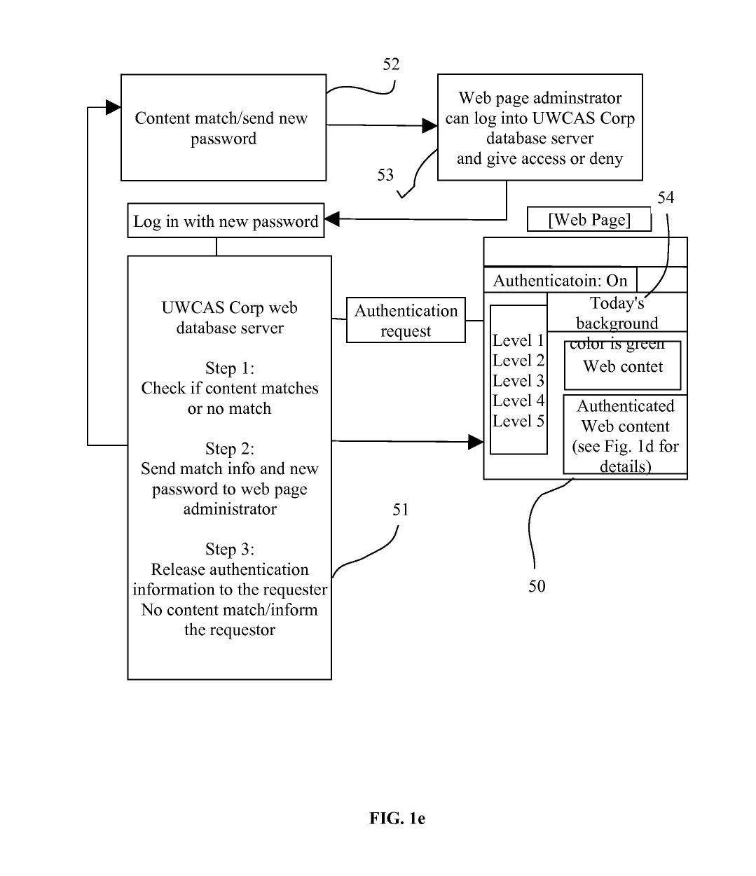

Web content authentication systems and methods: Web content authentication is extremely critical in the face of the tremendous amount of available information on the web. The first-generation version of the web content authentication invention, shown in FIG. 1a, creates a keyboard function, Control-A, to turn the authentication feature on. To turn this feature off, the user uses the escape ‘Esc’ button available on standard keyboards. The Control-A button will activate the web servers maintained by Universal Web Content Authentication Services (UWCAS Corp—www.uwcascorp.com).

By highlighting a domain name (10) or content (11) on a specific web page, authentication information can be received by the visitor within a pop-up window (12) or (13), respectively, as shown in FIG. 1a. While the first-generation authentication system will prove to be a significant improvement over what is available currently, its utility will be proven to be rather limited. This version will be immediately followed by a second-generation version of the authentication system described below.

A second-generation version of the web content authentication system will have a button called ‘Authentication’ (20) as a standard button on all web browsers (shown in FIG. 1b). By clicking on the down arrow, a drop-down menu (21) is created from which the user can choose the level of authentication desired. The available levels are (level 1—high authentication level and level 5—low authentication level).

Web domains can be authenticated by UWCAS Corp as shown in FIG. 1c. If a web domain is authenticated, a pop-up window (30) will show that that particular domain is authenticated by UWCAS Corp. Similarly, if a web domain is not authenticated, a pop-up window (31) will show the domain is not authenticated by UWCAS Corp. Authentication requests on web domains and web page content are sent to the UWCAS Corp servers to receive authentication information appropriate for the levels of authentication desired. For example, if a domain is authenticated at the lowest level (level 5) and a web visitor chooses a level 1 authentication, the web user gets notified that that level of authentication is not available for the domain. Similarly if a domain is authenticated at the highest level (level 1) and a web visitor chooses a level 5, the visitor receives information on level 5 authentication, as well as the other available levels of authentication.

Similarly, web content can be authenticated by UWCAS Corp as shown in FIG. 1d. A web visitor chooses the level of authentication (40) and highlights the content to be authenticated (41). Authentication information with multiple reviews with respective ratings will appear in a window (42).

UWCAS Corp will develop a database of information registered by web page owners/webmasters. Their domains are authenticated and their web content is authenticated to the desired levels, etc. UWCAS Corp will also create franchises to offer such web content authentication services worldwide. UWCAS Corp, and its franchises, will allow web page owners/webmasters to register information, will update the information as needed, and will allow the content to get authenticated online in real time.

FIG. 1e schematically shows all of the second-generation web content authentication system components. Once a web visitor requests for authentication about certain web content (50), UWCAS Corp servers will go through multiple steps (51) such as (a) to find a content match first for the content saved in its web databases, (b) to send content match information and new password to the web content owners/webmasters, and (c) to send authentication information to the web visitor. If there is a content match, UWCAS Corp will create a new randomly generated password and send that information to the web page owner either directly to the web page owner's web server or an intermediate web server (52). The owner will log back into the UWCAS Corp database server (53). If the log in is successful, the authentication information is released to the online visitor, who has requested such authentication information. If the log in has failed, the web visitor is notified that the content owner does not like to share content authentication information with the web visitor. This log in feature allows the content owner to control access to the authentication information. However, content owners may choose to automate this log in feature to allow access to authentication information by all web visitors.

If there is no content match in the database, the web visitor is directly notified that that content or domain name is not authenticated. This feature will ensure that the web owner does not add any additional content to the web site without receiving proper authentication from UWCAS Corp. In this regard, UWCAS Corp may choose to randomly change the background color of highlighted content (54). If the new background color, turned on by double clicking the content by a web visitor, and the old background color of the content or that of the unauthenticated new content, are different, then the web visitor automatically knows that that portion of the content is not up to date. In other words, UWCAS Corp will periodically change the background color of content and have access to web owner's web server to update the background color. This feature ensures any unauthorized new content will not receive the updated background color. UWCAS Corp will use different background colors based on the levels of authentication for the content as well.

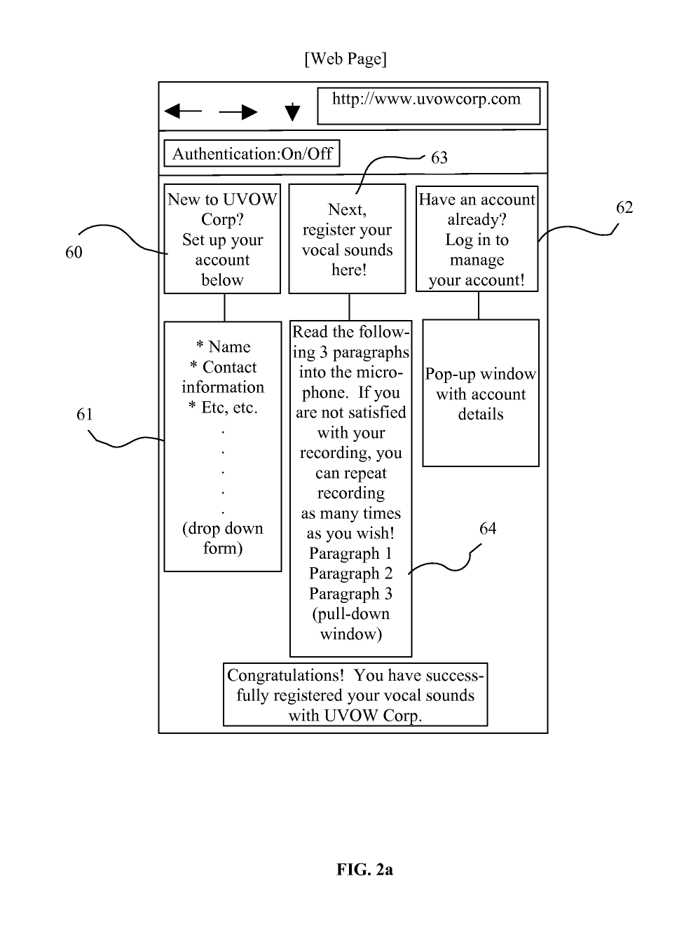

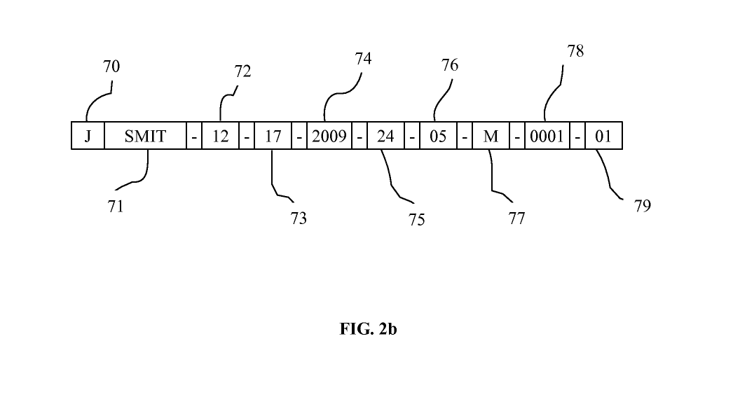

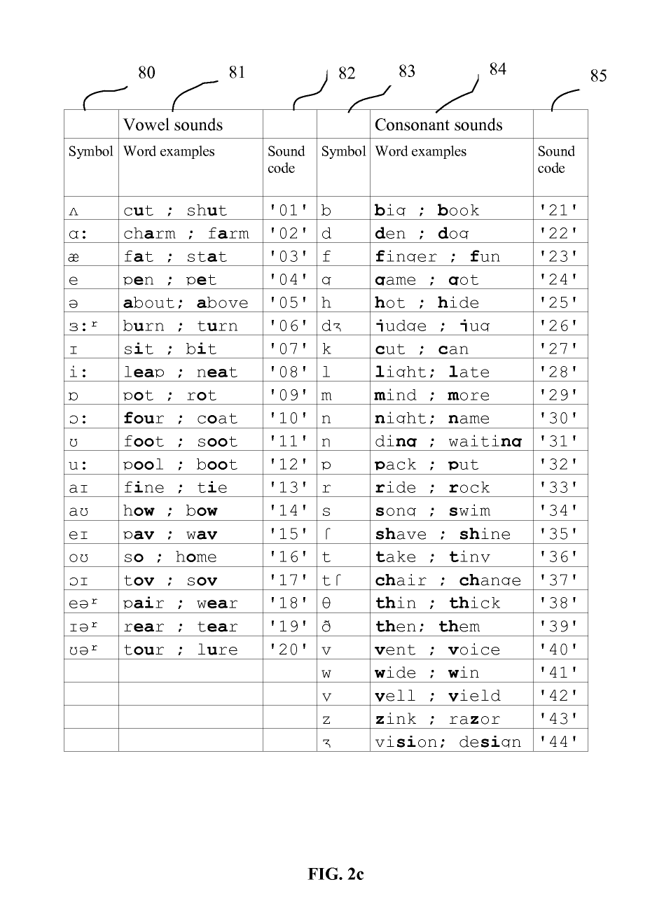

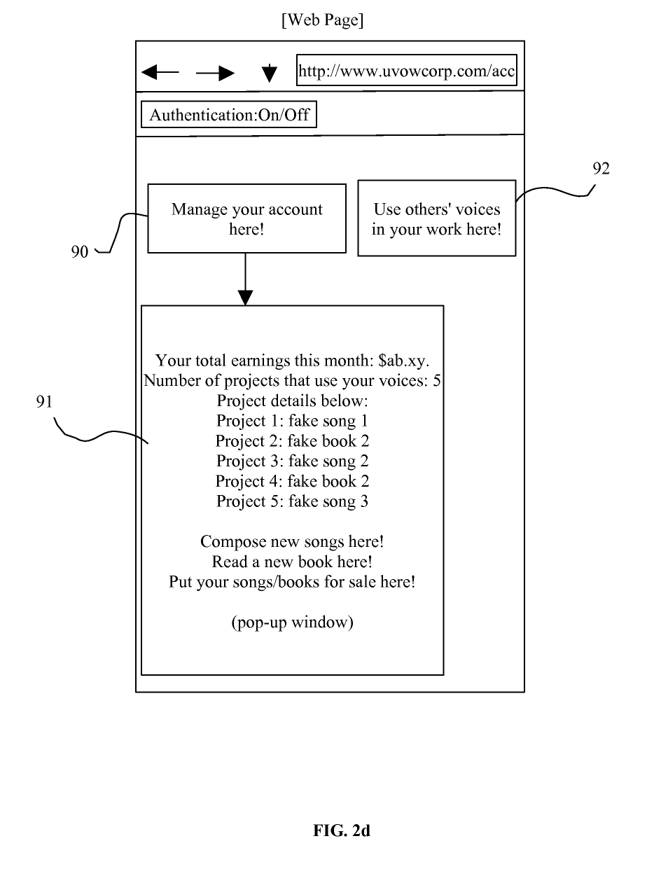

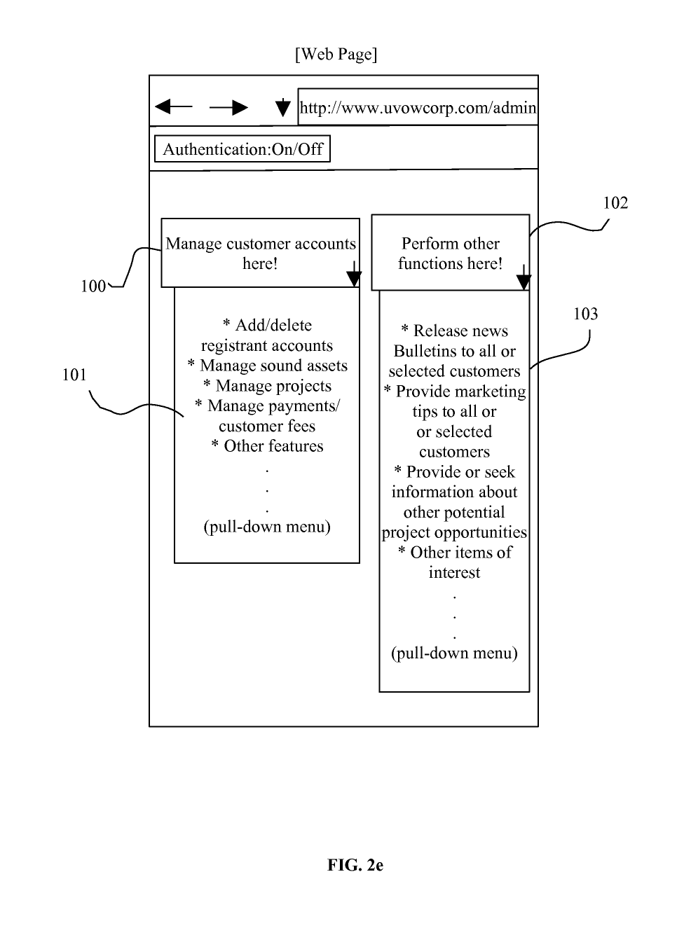

Web-based linguistic vocal sounds systems and methods: UVOW Corp will develop a web page (www.uvowcorp.com), where web visitors can go to register their forty-four sounds of the English language. First time vocal sound registrants will be required to fill in contact information by clicking on the set up account box (60). The first time registrant will fill in the information required in the drop down menu (61). The new web visitor will receive a username and a password to manage their UVOW Corp accounts online. Those who already have existing accounts will be directed to an area where they can manage their accounts online (62). After setting up an online account, the web visitor will be directed to an area to register his/her vocal sounds (63). Upon clicking box (63), a pop-up window appears (64), containing three or more paragraphs of text written in English. The web visitor will read these paragraphs into a microphone connected to their computer. UVOW Corp will isolate twenty vowel sounds and twenty-four consonant sounds from the paragraphs read. A web page schematic of this part of the system is shown in FIG. 2a.

UVOW Corp will develop, as part of this invention, a strategy to identify, isolate, and save those unique vocal sounds into a database. This vocal sound registration code or nomenclature is shown in FIG. 2b. These vocal sounds are identified in the database based on the first letter of the first name (70), the first four letters of the last name (71), the month (72), the day (73), and the year (74) the sounds are registered, age of the registrant in years (75) and months (76), sex (77), a country code (78), and the sound number (79). For example, if Joe Smith, who is 24 years and 5 months old, who lives in the USA, registers his vocal sounds on Dec. 17, 2009, the sound registration code will look like the following:

| | |
|---|---|
| JSMIT-12-17-2009-24-05-M-0001 | -01 |
| . . . | -02 |
| . . . | -03. |

Database query capabilities will be used to pull these sound files out based on the vocal sound registration code developed as part of this invention.

FIG. 2c shows all forty-four vocal sound symbols, word examples, and sound codes. The twenty vowel sound symbols (80), corresponding vowel sounds with word examples (81), and corresponding sound codes (82) are shown in FIG. 2c. Similarly, the twenty-four consonant sound symbols (83), corresponding consonant sounds with word examples (84), and corresponding sound codes (85) are also shown in FIG. 2c.

UVOW Corp will build a web portal for its customers. The schematic of this web portal is shown in FIG. 2d. This customer web portal will have two main option windows. The first option window (90) allows the user to manage his/her account. When the web visitor clicks after logging in, a pop-up window will show payment information, different projects his/her vocal voices have been used in as of today (91). This is also where a user can compose songs, develop audio books and/or put their projects up for sale or for profit sharing with other users. The second option window (92) will allow the customer to use others' voices in their work such as in composing songs, etc. The customer will have to agree to all terms, set forth by UVOW Corp as well the owners of those vocal sounds, in order to use others' sound assets.

UVOW Corp will develop a web portal for its system administrators also that will allow them to manage different registrant accounts, registrants' sound assets, payments/fee collections, etc. A web page schematic of this portion of the invention is shown in FIG. 2e. This web portal will take system administrators to a window (100) from where to manage customers' accounts. System administrators will use username/password to log into the system. Upon log in, a pull down menu (101) with various options will appear, where the system administrators can add, delete accounts, etc. The system administrators can also perform additional functions by going to another window (102). By clicking on this box, another pull-down window (103) will appear, where the system administrators can perform additional functions such as releasing news bulletins to all or a segment of customers, providing marketing tips to all or a segment of customers, managing its own marketing efforts, providing or seeking information about other potential projects for generating new revenue streams for all or specific customers, etc.

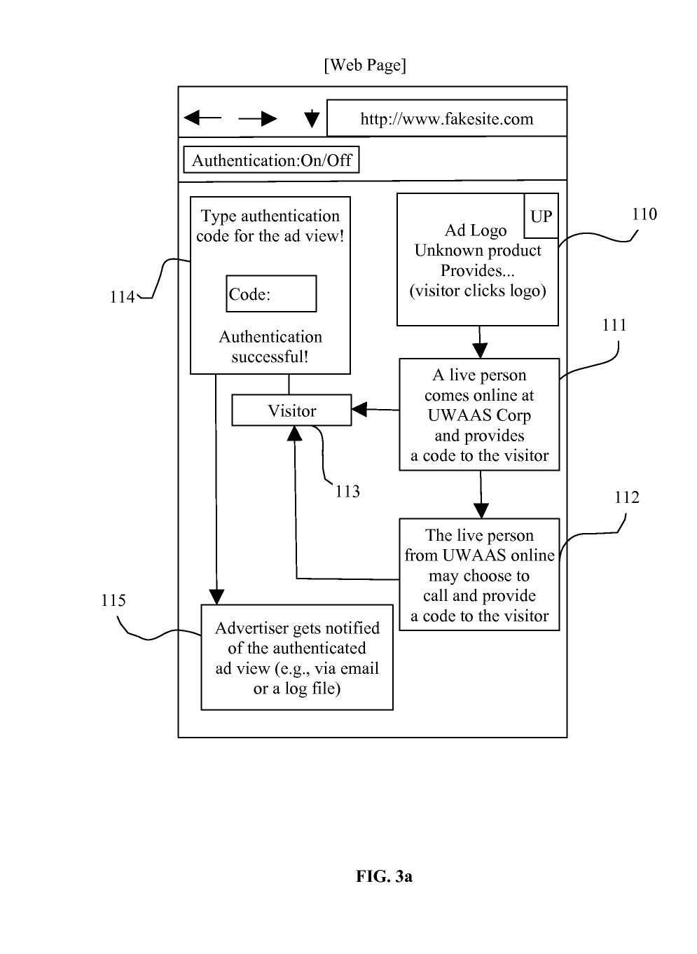

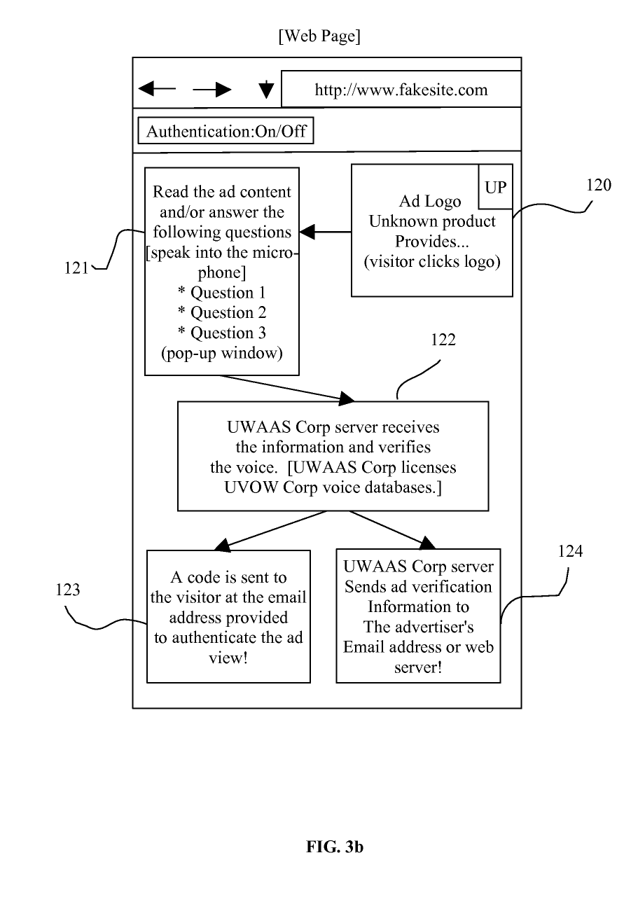

Web advertisement authentication systems and methods: All views of web advertisements need to be authenticated and tracked and accounted for to provide value and statistics for web advertisers that invest in online advertising. The first-generation version of the advertisement authentication system as web page schematic is shown in FIG. 3a. This system is about how to authenticate and track and account for online views of web ads. When a web visitor clicks on the hyperlink of a web ad or a company logo (110), the visitor gets a live person online within a chat window (111) from Universal Web Ad Authentication Services (UWAAS Corp—www.uwaascorp.com) and/or choose to call the web visitor on the phone at the phone number provided by the visitor (112). The live person will have the visitor read the content of the ad and/or ask additional questions for which the visitor should provide satisfactory answers. Upon receiving satisfactory answers, the live UWAAS Corp person will provide a code to the visitor. The web visitor (113) will type the code into another pop-up window (114) to authenticate the ad view. Upon acceptance, the advertiser gets notified of the authenticity of the view and the accumulated statistics for that specific ad (115).

The advertiser pays to the hosting web page owners as well as to UWAAS Corp for the authentication service. The web visitor will benefit from this ad authentication procedure, too, for spending his or her time to get authenticated. In other words, the web visitor will be allowed to redeem the code for a price discount at the time of purchase of the product or service advertised.

The second-generation version of the web ad authentication system, whose web page schematic is shown in FIG. 3b, will work more efficiently than the first version by eliminating the need for live persons to authenticate the ad views. In this version, when a web visitor clicks a web ad hyperlink or a company logo (120), a pop-up window appears as before. The visitor is prompted to read the content and/or answer questions into a microphone (121). That voice information is verified against a UWAAS Corp's voice database server (122). The voice database is licensed from UVOW Corp by UWAAS Corp. If there is a match of the voices, a verification code will be generated and sent to the web visitor at the email address provided by the visitor (123). If ad authentication is successful, the verification information and accumulated statistics will be automatically sent to the advertiser as before (124). For this advanced authentication system version to work completely, however, the voice database must be populated with millions of online visitors first. In the meantime or along with the second-generation version, the first-generation version will provide the much valuable web ad authentication service desired by online advertisers.

This second-generation web ad authentication technology will also help control and eventually eliminate multiple views by the same web visitor to gain unethical clicks for monetary gain, especially within a certain set period of time such as twenty-four hours. This will also eliminate any automatic computer generated clicks.

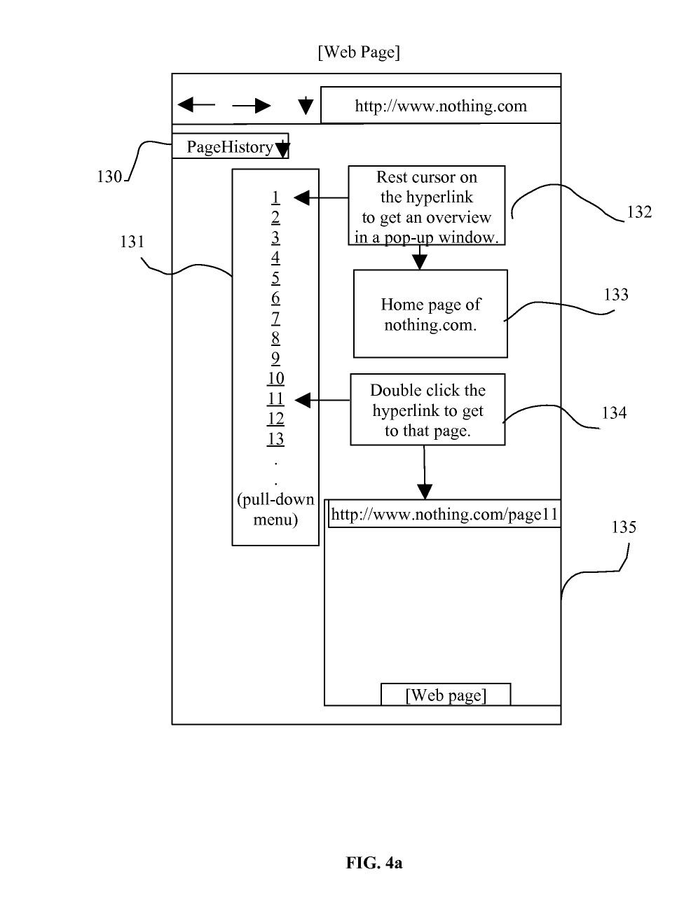

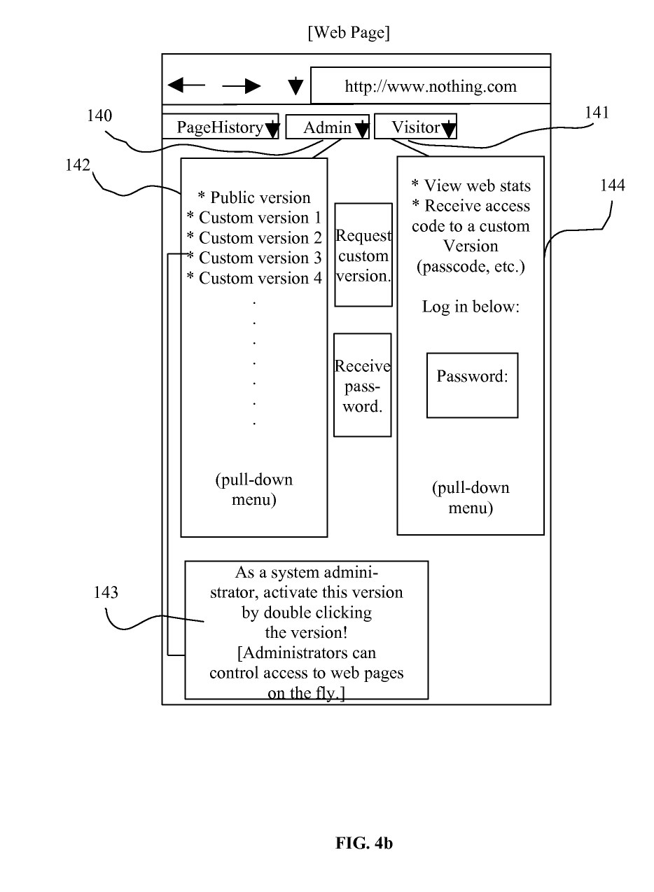

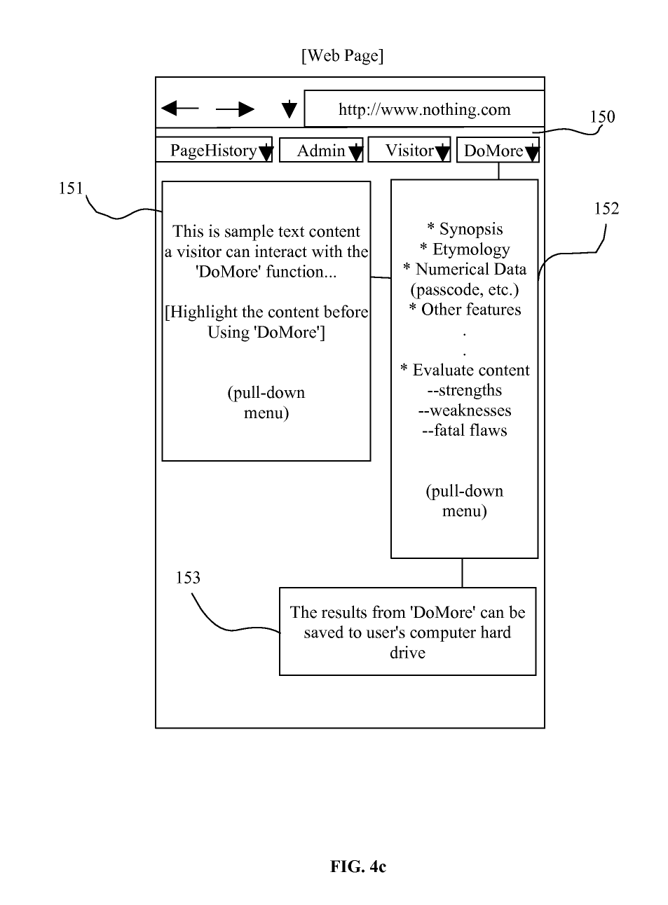

Web-based functionality/interactivity systems and methods: A new button on the web browser page called ‘PageHistory’ (130) is created, as shown in FIG. 4a in web page schematic form. A pull down menu (131) will appear by clicking the arrow. The pull down menu will have numbered hyperlinks to show all the pages viewed sequentially by a web visitor during a web browsing session. By resting the cursor on a hyperlink (132), a pop-up window will appear with an overview of the hyperlink (133) and by double clicking the hyperlink (134), the web visitor will be taken to that web page (135). By clicking the PageHistory button once, the

PageHistory gets reset. By double clicking this button, one can get back to the last page viewed.

Two buttons called ‘Admin’ (140) and ‘Visitor’ (141) are created on the web browser page to offer web page owners and visitors additional functionality, respectively. This portion of the invention is shown as web page schematic in FIG. 4b. By clicking the arrow on the Admin button, a pull down menu will appear (142). This menu will have several options listed such as: public version (default), custom version 1, custom version 2, custom version 3, etc. The system administrator can activate any version by logging in with a password. Once logged in, the system administrator can also control access to different pages of a version to be viewed by that specific visitor (143). This invention offers the ability to have multiple web sites within web sites. System administrators, without having to log into the web servers, can externally manage access to various versions of web sites and the individual pages within them. This external access feature is quite useful not only from system security standpoint but from flexibility to provide administrator privileges to multiple personnel. For example, businesses can use this ability to enable many sales people to provide customized sales/marketing presentations simultaneously to multiple potential customers and other stakeholders. Similarly, the Visitor button will allow the visitor to receive passwords and other critical information to navigate these custom web sites and pages within them (144).

Another button called ‘DoMore’ (150) is created on the web browser page as shown in FIG. 4c. This button will allow the visitor to interact more with the content being viewed than what is allowed at this time. The web visitor will highlight the content (151) first and click on the ‘DoMore’ button. Upon clicking the ‘DoMore’ button, a web visitor will see a pull down menu (152) with multiple options such as request synopses of the content, etymological origins of certain words, analyze and display numerical data, evaluate strengths/weaknesses/flaws of the content being viewed, etc.

To use these options rather than to passively read content as it currently is, the visitor can highlight parts of a web page or the content of an entire document to analyze, etc. using the ‘DoMore’ button. Summary documents, resulting from ‘DoMore’ analyses, can be saved to a web visitor's computer hard drive and/or the web visitor can print the reports after using any of the ‘DoMore’ options.

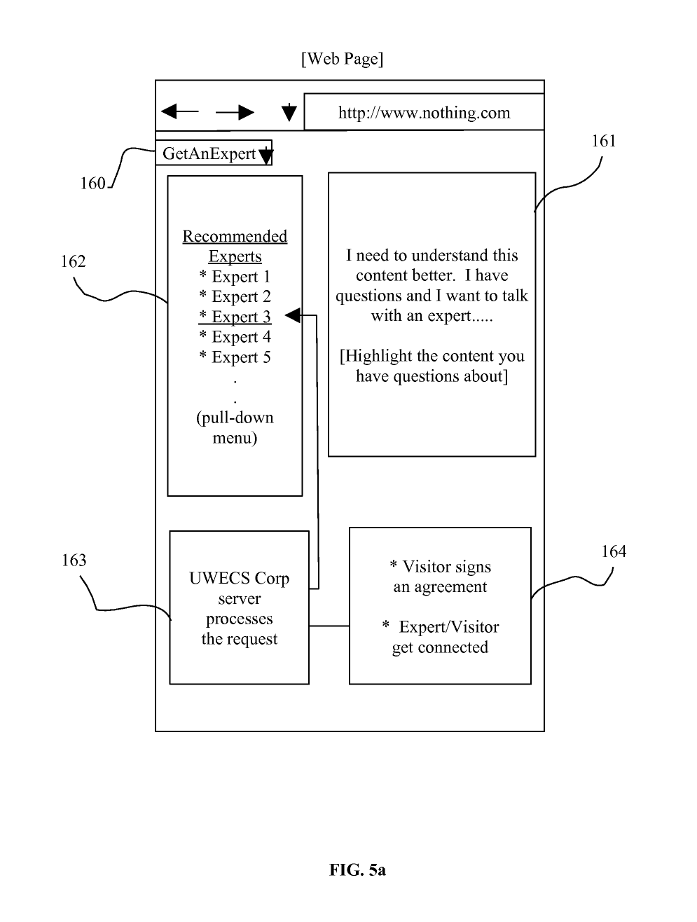

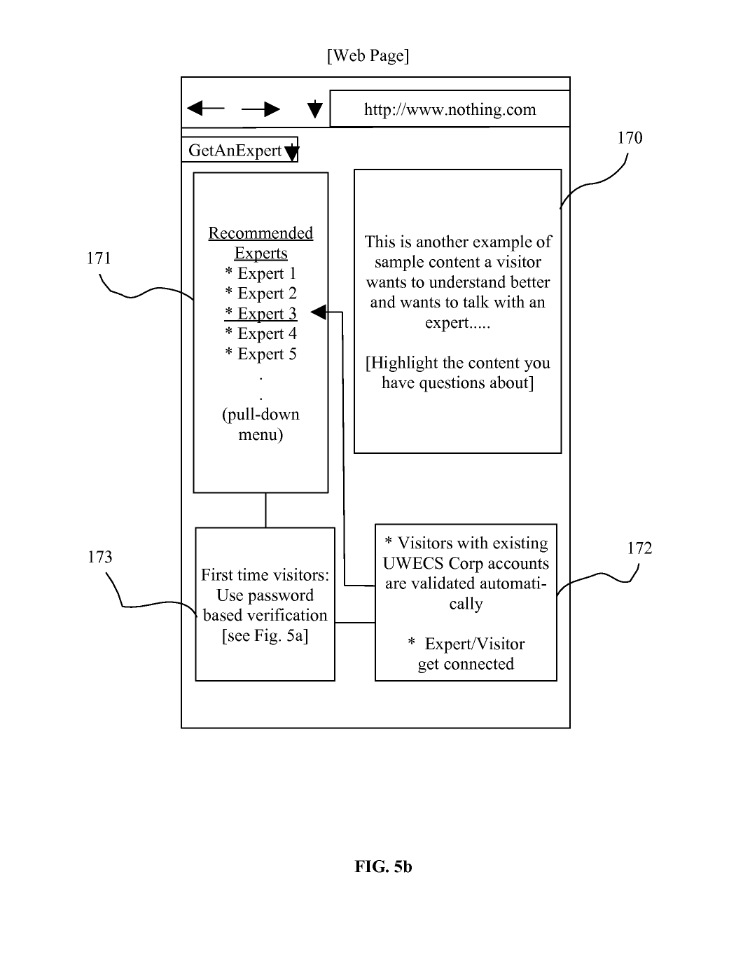

Web-based expert consulting systems and methods: A company called Universal Web Expert Consulting Services (UWECS Corp—www.uwecscorp.com) is formed to offer expert consulting services to web users worldwide. A ‘GetAnExpert’ system is shown as a web page schematic in FIG. 5a. This schematic illustrates how first-time web users or those users that do not choose to set up accounts with UWECS Corp.

UWECS Corp recruits and trains expert consultants in various subject areas from many parts of the world. UWECS Corp may choose to franchise this business model as well to handle the anticipated large business volume and to accommodate the expert consulting needs of people that speak different languages around the world. UWECS Corp will collect and provide such information on areas of expertise, about availability of experts, the language preference of the experts, their hourly rate, etc.

When a web visitor gets the pull down menu by clicking the arrow on the ‘GetAnExpert’ button (160), the pull down menu (162) will show five or more experts with the expertise in the subject area(s) of the highlighted web content (161). A UWECS Corp server (163) gets notified of the request when a web visitor clicks on a specific expert. The web visitor will provide contact and payment information to UWECS Corp. The web visitor will also read service terms and sign an agreement (164). Upon signing the agreement, UWECS Corp will give a go-ahead to the expert to interact with the web visitor. The consulting fee will be based on the time spent in discussing the subject matter. If the visitor decides to terminate the call before the first 90 seconds, then there will not be any charge to the web visitor. Web visitors may choose to discuss the subject matter with experts online as well as on the phone.

Similarly, repeat web visitors with established accounts with UWECS Corp can directly highlight the content (170) they need help with and select the expert of their choice from the pull-down menu (171). The expert and the web visitor automatically get connected here [172]. A web page schematic of this portion of the system is shown in FIG. 5b. This web page will have a box (173) for first-time web visitors as well.

Web-based logo branding systems and methods: This invention has four main parts: (a) a method to identify company logos around the world automatically to include in the Global Logo Mania's non-member directory, (b) development of a system to incentivize active companies by displaying their logos with more ‘web time’, (c) building a platform that will generate more company reviews by viewers, companies, and industry experts, and (d) development of a platform that will give rise to creative logo designs.

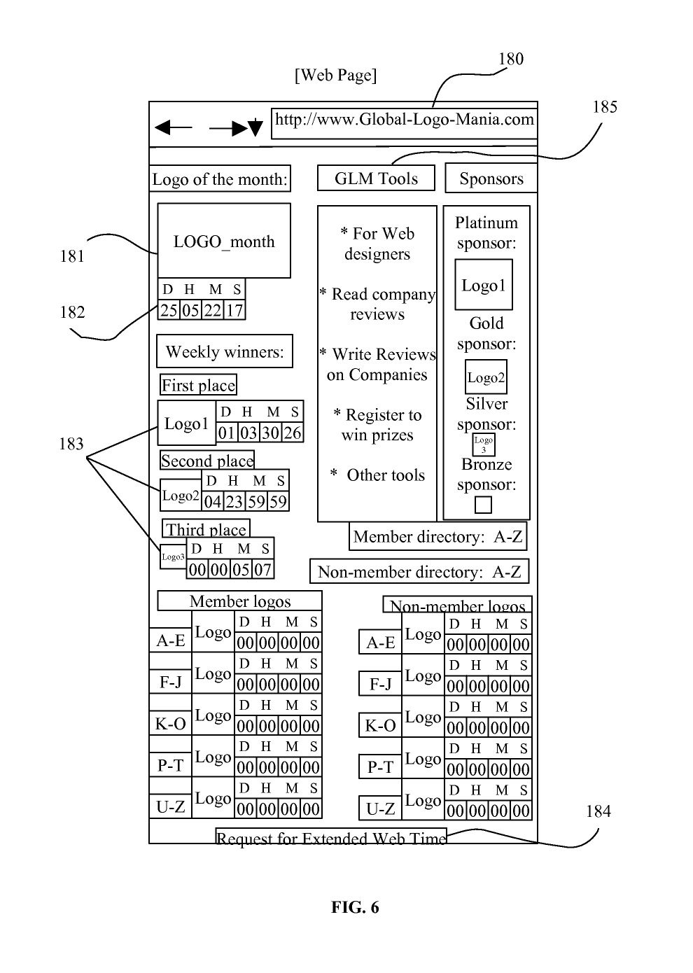

Global Logo Mania (www.Global-Logo-Mania.com) will develop a web interface as part of the invention, shown as a web page schematic in FIG. 6. This web page schematic shows the web domain name (180), the logo of the month (181), the time counter shown in days-hours-minutes-seconds (DHMS) format (182). Additionally, three (first-place, second-place, and third-place) weekly logo winners are displayed as well (183), with their respective time counters. Also shown on this web interface is the request for ‘Extended web time’ box (184).

On this web interface, non-members can increase their assigned web time of five minutes to fifteen minutes by simply entering the request into a button provided on the web page. Non-member logos are displayed for five minutes alphabetically. If the request is made before the logo's turn for the extended web time, the logo gets the extended web time of fifteen minutes. If the request is made after the logo's turn, it will have to wait until the next web cycle to receive the privilege of the extended web time. One can request extended web time for up to two web cycles only in advance. In other words, a non-member can request extended web time for the current web cycle as well as for one future web cycle. Member logos, on the other hand, get thirty minutes of web time and, if requested for extended web time, can get forty-five minutes of web time. Members can request for extended web time for up to five web cycles ahead of time. To receive member privileges, member companies will pay a yearly member fee to Global Logo Mania (GLO). A web cycle is defined as the display of all logos within a member or non-member directory, displayed for their specific web time, in an alphabetical order. Web time is the time a logo stays on display with a digital time counter button adjacent to the logo.

The web page will allow viewers, companies, and other industry experts to write reviews about companies whose logos are in the member directory. Such reviews will generate critical information for major web based search engines. Reviews about non-members are not allowed.

The web page will also offer web design tools (185) to web designers so the designers can develop and save their designs on the GLM server. First, interested web designers will have to register and set up a free designer account on the GLM server. Best new logos will be selected each month and the designers of those logos will potentially win prizes. These new logo winners will be selected from the total votes received from registered logo viewers on a monthly basis.

There will be various promotional aspects built into the GLM web interface system. For example, registered logo viewers can receive promotional materials (such as t-shirts, coffee mugs, hand bags, etc.) with the logo they have viewed or the ‘Featured Logo’ of the month.

The primary goal of the invention is to make online viewers notice logos, interact with the logos longer, write about the logos and the companies the logos represent, win prizes and receive price discounts, and finally have fun with the whole logo-viewing web experience.

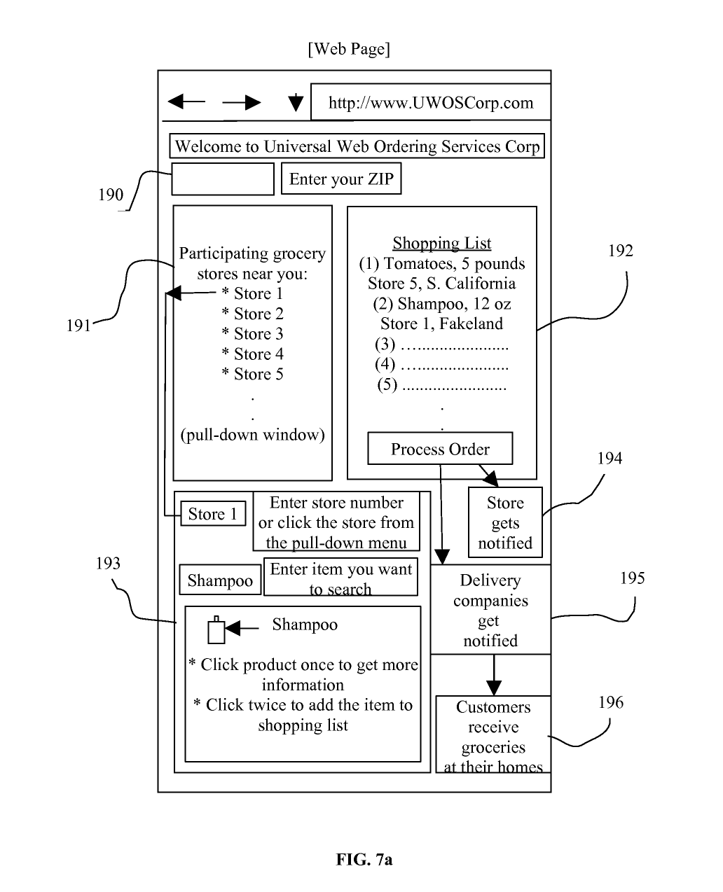

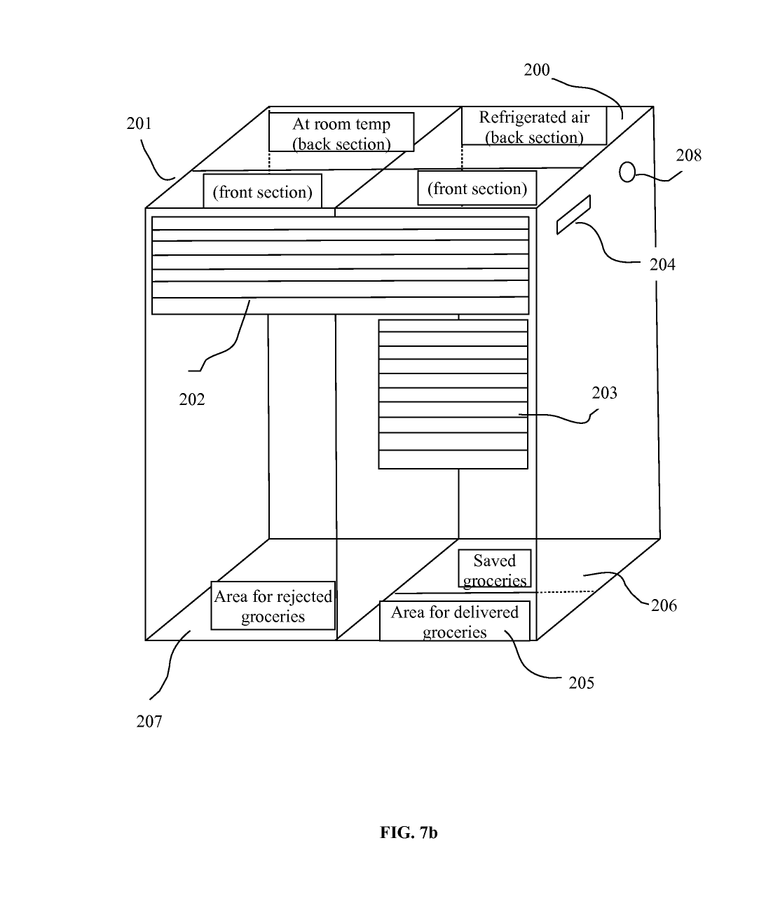

Web-based grocery shopping systems with innovative delivery methods: Groceries can be ordered online and delivered to one's home without ever setting foot in grocery stores. This can be made possible by the web technology available today. The invention described here is about developing a first-generation version of the web based grocery ordering/delivery system. This is shown as a web page schematic in FIG. 7a. A company called Universal Web Ordering Service Corp (UWOS Corp—www.uwoscorp.com) will work with interested grocery stores and get their stores fully connected on the web. This means that all grocery items available at a grocery store can be viewed remotely online in real time. UWOS Corp will provide the required computer infrastructure and training to the participating grocery stores with respect to the web ordering/delivery system developed here as part of the invention.

Once grocery stores are fully connected on the web with the required infrastructure, UWOS Corp will develop and use the web ordering interface and recruit local trucking companies to deliver groceries to its customers. Customers interested in using this web ordering service will enter their ZIP in the box (190) shown on the web interface. A pull-down window (191) with a list of the participating grocery stores nearby will appear. A shopping list will appear in a separate window (192). Customers can choose the store of their choice by entering a store number or by clicking the store from the list. Another window will ask to enter the item, which will pull a window to display a single item or a number of brand choices (193). When the desired item is clicked on, it gets added to the shopping list (192). Upon completing the selection of all items, customers press the ‘Process Order’ button. The selected stores get notified of the order (194). Similarly, delivery companies get notified of the order as well (195). Customers receive groceries at home (196). For this first-generation delivery methods, truck drivers will be required to hand-deliver groceries to houses.

A second-generation version of the delivery system will have a refrigerated storage unit built into the exterior walls of participating houses. These storage units can be readily developed using existing refrigeration technology and other card reader based systems for secure access to the storage units. These units are shown in FIG. 7b. These storage units will have two sections, on the left and right hand sides and each of these sections will contain a back section (200) and a front section (201) as well. The back section, on the right hand side, will have cold air for frozen grocery items and the front section, on the right hand side, will have air at room temperature. Similarly, the front and back sections, on the left hand side, will be maintained at certain temperature to store unwanted or rejected grocery items. There is a front shutter door (202) that covers the entire front side of the storage unit. There are two smaller shutter doors on the inside to keep the refrigerated air (203) and air at room temperature (not shown), on the right hand side and the left hand side, respectively. The exterior shutter door, with access to the delivery personnel, can be opened or closed with an access card or the bar code on the grocery packages themselves (204). After opening the exterior door with the access code and putting the grocery items separated into two piles for cold air and at room temperature and placed in their respective locations (205), the deliver person will close the door by pushing a ‘close’ button (208). As soon as the exterior door is closed shut, the right hand side interior door will automatically open and pull the grocery packages into the back of the storage area (206) and will close that shutter door (203) back again. This way, the next delivery person will not have access to any of the previously delivered packages. Only the storage unit owners can open the back sections through another set of back doors (not shown), facing the house, and obtain the grocery items they have ordered. Rejected or unwanted items are placed within the left hand side sections of the storage unit (207) so the truck drivers can take them back to the stores.

With this novel delivery system, the delivery truck drivers will unload the groceries into the storage units, without having to see a household member to hand over the groceries. This will be analogous to how a mailman delivers mail to people's mailboxes today.

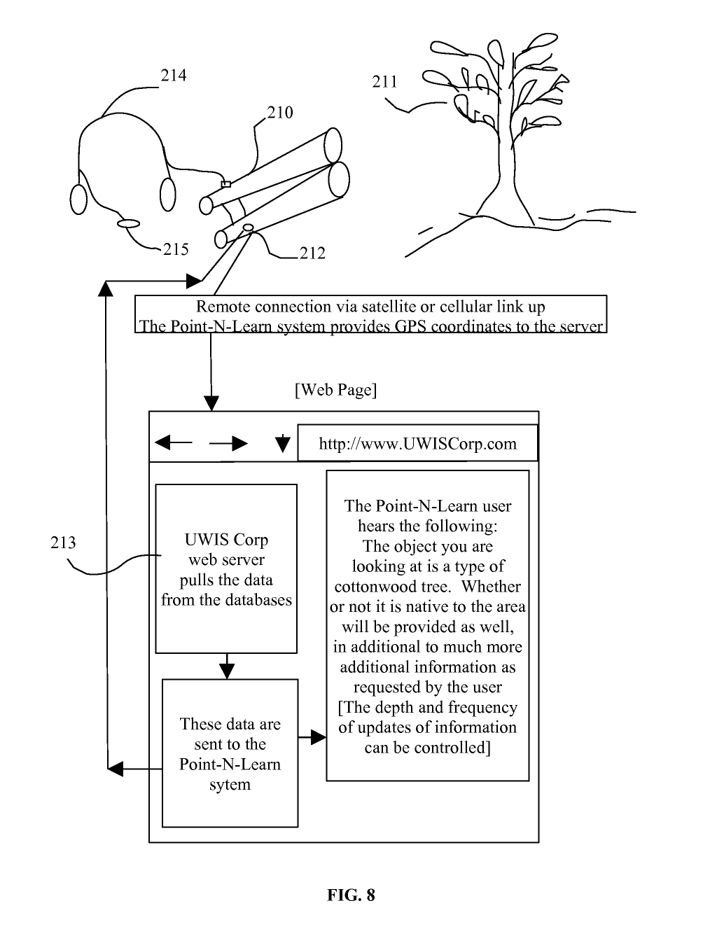

Web based Point-N-Learn systems and methods: A Point-N-Learn system is developed with satellite based or cellular based web link up capability. This system is shown in FIG. 8. When this system (210) is turned on and pointed towards an object (211), that object's position coordinates are registered through Global Positioning System (GPS) and those coordinates are sent to the web server (213) loaded with the databases via a remote connection device (212). The user will hear the information with the headphones (214). The user may interact with the database via the microphone (215) as an additional feature, for example, by using a voice activated recognition system offered by UVOW Corp, to order better resolution information, etc. This will be considered a second-generation feature for the Point-N-Learn system disclosed here. These databases are developed for all participating areas of interest and updated at the frequency desired. Using the coordinate information, the web server will be able to pull the correct information from the databases and send that information back to the user.

Many variants of the Point-N-Learn systems (e.g., similar to binoculars, headsets, flashlights, etc.) can be devised. The levels of data resolution desired, etc. can be adjusted as desired as well. A company called Universal Web Information Services (UWIS Corp—www.uwiscorp.com) will create the databases for its client sites and update and maintain the databases periodically. The databases will be created from a combination of data sources. For example, some of the data may be obtained from satellite imagery, other data might come from cameras, camcorders, etc. Clients will choose the level of detail or the data resolution to be produced for the Point-N-Learn customers.

What is claimed is:

1. A web based system comprising:
a data server,
a web server; a client server with web browser capability; and a plurality of web servers to utilize, manipulate, and create web content.

2. The system of claim 1 wherein web content, available on web server, is utilized for authenticating web content using a plurality of web servers.

3. The system of claim 1 wherein web content, available on web server, is utilized for authenticating web advertisements using a plurality of web servers.

4. The system of claim 1 wherein web content, available on web server, is manipulated using new web browser buttons and a plurality of web browsers.

5. The system of claim 1 wherein web content, available on web server, is utilized to provide expert web consulting using a plurality of web servers.

6. The system of claim 1 wherein web content is created from company logos and a plurality of web servers.

7. A web based system comprising:
a data server,
a web server; a client server with web server capability; and a plurality of web servers to utilize, manipulate, and create web content; and a plurality of external devices.

8. The system of claim 7 wherein web content, in the way of vocal sounds, is created by a plurality of web servers and a microphone.

9. The system of claim 7 wherein web content is utilized by a plurality of web servers, web cameras, truck drivers.

10. The system of claim 7 wherein web content is utilized by a plurality of web servers, web cameras, truck drivers, and storage units.

11. The system of claim 7 wherein web content, in the way of video data and audio data, is created by a plurality of web servers, cameras, camcorders, satellites, microphones, and a point-n-learn device.

12. A method of authenticating world-wide-web content, the method comprising the steps of:
permitting a user to request by web browser that particular world-wide-web content be authenticated;
receiving the request at an authentication server; and
reporting to the user whether the domain containing the world-wide-web content is authenticated by the authentication server.

13. The method of claim 12 additionally comprising the step of reporting to the user whether the world-wide-web content displayed by the web browser is authenticated by the authentication server.

14. The method of claim 13 wherein the step of reporting to the user whether the world-wide-web content displayed by the web browser is authenticated comprises noting to the user which content is authenticated and which is not.

15. The method of claim 14 wherein noting to the user which content is authenticated and which is not comprises altering background colors of the content.

16. The method of claim 12 wherein the reporting step employs a plurality of levels of authentication.

17. The method of claim 12 wherein the world-wide-web content comprises vocal sounds.

18. The method of claim 7 wherein the vocal sounds are authenticated against an individual person's pre-recorded vocal sounds registered with the authentication server.

19. The method of claim 12 wherein the world-wide-web content comprises advertising to be authenticated.
